(19) United States
(12) Patent Application Publication
(10) Pub. No.: US 2026/0166431 A1
(43) Pub. Date: Jun. 18, 2026

(54) INFORMATION PROCESSING DEVICE, INFORMATION PROCESSING SYSTEM, INFORMATION PROCESSING METHOD, AND INFORMATION PROCESSING PROGRAM

(71) Applicant: Sony Interactive Entertainment Inc., Tokyo (JP)

(72) Inventors: Yumi Ueda, Chiba (JP); Naoki Kudo, Tokyo (JP); Airi Takeuchi, Saitama (JP)

(73) Assignee: Sony Interactive Entertainment Inc., Tokyo (JP)

(21) Appl. No.: 19/158,586

(22) PCT Filed: Mar. 17, 2023
(86) PCT No.: PCT/JP2023/010683

§ 371 Date: Aug. 21, 2025

(51) Int. Cl. A63F 13/54; A63F 13/424; A63F 13/87; H04S 7/00

(52) U.S. Cl. CPC A63F 13/54; A63F 13/424; A63F 13/87; H04S 7/303; H04S 2400/11

(57) ABSTRACT

An information processing device (20A) includes a first acquisition section (21A) that acquires positional information concerning a first character corresponding to a first user and a second character corresponding to a second user in a virtual space, a second acquisition section (21A) that acquires sound information concerning the second user, a sound processing section (221A) that processes the sound information according to a relative positional relation between the first character and the second character in the virtual space, and a sound output section (24A) that outputs the processed sound information to the first user.

### TECHNICAL FIELD

The present invention relates to an information processing device, an information processing system, an information processing method, and an information processing program.

### BACKGROUND ART

There is known voice chat in which a speech communication is performed by use of sound information. In recent years, it has particularly become popular for a user to play a game while performing voice chat with another user at a distant place such as a user who is playing a game or a person browsing a moving image representative of a play situation of a game.

The invention described in PTL 1 discloses a technology for suppressing a load on a device or a server during voice chat and reducing communication volume of a sound data communication path.

### CITATION LIST

### Patent Literature

[PTL 1]

PCT Patent Publication No. WO2020/170946

### SUMMARY

### Technical Problem

In voice chat, a speech communication is performed by use of sound information, and there is a demand for obtaining higher senses of presence and immersion suited for each purpose of use. The present disclosure has been devised with the aim of solving at least part of the above problem, and one of objects of the present disclosure is to provide an information processing device, an information processing system, an information processing method, and an information processing program for realizing voice chat that reflects a situation of a virtual space and enables obtainment of higher senses of presence and immersion.

### Solution to Problem

According to a first aspect of the present invention, there is provided an information processing device including a first acquisition section that acquires positional information concerning a first character corresponding to a first user and a second character corresponding to a second user in a virtual space, a second acquisition section that acquires sound information concerning the second user, a sound processing section that processes the sound information according to a relative positional relation between the first character and the second character in the virtual space, and a sound output section that outputs the processed sound information to the first user.

According to a second aspect of the present invention, there is provided an information processing system including a first information processing device that is the information processing device described above, and a second information processing device capable of operating a plurality of characters corresponding to a plurality of respective users in the virtual space, the second information processing device including an output section that outputs the positional information concerning the first character and the second character among the plurality of characters to the first information processing device.

According to a third aspect of the present invention, there is provided an information processing method including a first acquisition procedure of acquiring positional information concerning a first character corresponding to a first user and a second character corresponding to a second user in a virtual space, a second acquisition procedure of acquiring sound information concerning the second user, a sound processing procedure of processing the sound information according to a relative positional relation between the first character and the second character in the virtual space, and a sound output procedure of outputting the processed sound information to the first user.

According to a fourth aspect of the present invention, there is provided an information processing program for causing a computer to execute a first acquisition step of acquiring positional information concerning a first character corresponding to a first user and a second character corresponding to a second user in a virtual space, a second acquisition step of acquiring sound information concerning the second user, a sound processing step of processing the sound information according to a relative positional relation between the first character and the second character in the virtual space, and a sound output step of outputting the processed sound information to the first user.

### BRIEF DESCRIPTION OF DRAWINGS

FIG. 1 is a schematic diagram illustrating an outline configuration of an information processing system according to an embodiment.

FIG. 2 is a diagram for explaining positional information according to the embodiment.

FIG. 3 is another diagram for explaining positional information according to the embodiment.

FIG. 4 is another diagram for explaining positional information according to the embodiment.

FIG. 5 is another diagram for explaining positional information according to the embodiment.

FIG. 6 is a flowchart illustrating an example of a processing method according to the embodiment.

FIG. 7 is another flowchart illustrating an example of the processing method according to the embodiment.

FIG. 8 is another flowchart illustrating an example of the processing method according to the embodiment.

FIG. 9 is another flowchart illustrating an example of the processing method according to the embodiment.

### DESCRIPTION OF EMBODIMENT

An embodiment of the present invention will hereinafter be described on the basis of the drawings

### Outline Configuration of Information Processing System

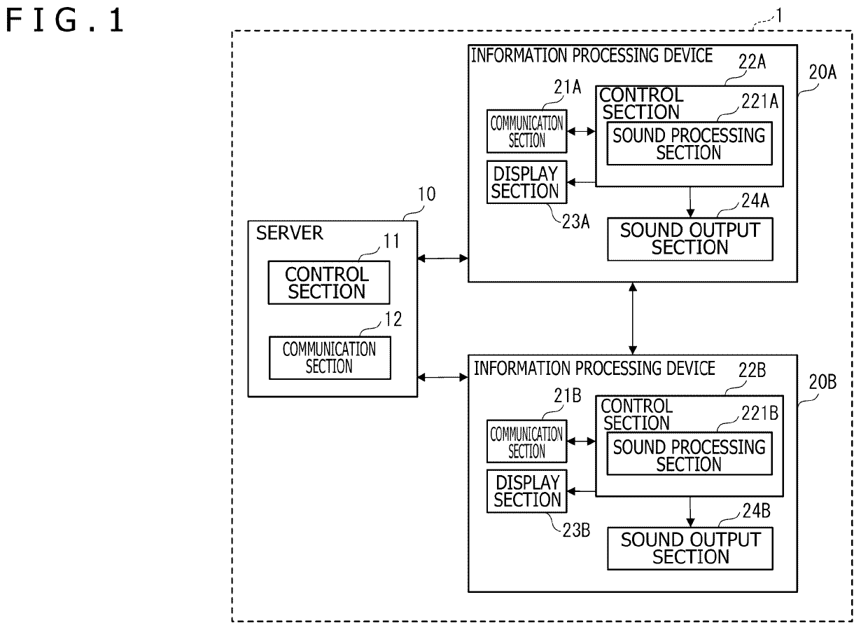

FIG. 1 is a schematic diagram illustrating an outline configuration of an information processing system according to the embodiment.

An information processing system 1 according to the embodiment is a game system including a server 10, an information processing device 20A, and an information processing device 20B as illustrated in FIG. 1. While the two information processing devices 20A and 20B are illustrated in the present embodiment for convenience of explanation, it is also possible that three or more information processing devices are included in the information processing system 1.

In the information processing system 1, the server 10 causes a game to progress according to information transmitted from the information processing device 20A and the information processing device 20B. Further, the information processing device 20A and the information processing device 20B execute voice chat in which a speech communication is performed by use of sound information without intervention of the server 10.

### Configuration of Server

The server 10 is a server (could server, for example) communicably connected to the information processing device 20A and the information processing device 20B via the Internet communication network in a wireless manner.

The server 10 includes a control section 11 and a communication section 12 and executes various kinds of processing operation based on information output from the information processing device 20A and the information processing device 20B.

The control section 11 has a processor that operates in accordance with a program stored in a memory or received via a communication interface.

The communication section 12 is connected to the information processing device 20A and the information processing device 20B in a wireless or wired manner and receives information that concerns control of the game and is output from the information processing device 20A and the information processing device 20B. Further, the communication section 12 outputs information concerning progress of the game to the information processing device 20A and the information processing device 20B and also outputs display images to be displayed on display sections of the information processing device 20A and the information processing device 20B to the information processing device 20A and the information processing device 20B.

It is to be noted that the information output by the communication section 12 to the information processing device 20A and the information processing device 20B includes positional information concerning a plurality of characters in a virtual space of game progressing on the server 10. More specifically, the information includes positional information concerning a first character Ca corresponding to a user Ua of the information processing device 20A which is a first user and positional information concerning a second character Cb corresponding to a user Ub of the information processing device 20B which is a second user.

### Configuration of Information Processing Device

The information processing device 20A includes a communication section 21A, a control section 22A, a display section 23A, and a sound output section 24A.

The communication section 21A is connected to the communication section 12 of the server 10 in a wireless or wired manner and is also connected to the information processing device 20B in a wireless or wired manner. The communication section 21A acquires the information concerning the progress of the game from the communication section 12 of the server 10 and outputs the information concerning the control of the game to the communication section 12 of the server 10.

The control section 22A has a function of a sound processing section 221A that is implemented by a processor operating in accordance with a program stored in a memory or received via a communication interface. The function of the sound processing section 221A will be described later.

The display section 23A has, for example, a display element such as a liquid crystal display (LCD) or organic electroluminescence (EL). It is to be noted that the display section 23A may be a display device provided outside the information processing device 20A. For example, the display section 23A may be a display device for a wearable-type device such as a head-mounted display (HMD) unit, augmented reality (AR) glasses, or mixed reality (MR) glasses.

The sound output section 24A includes a speaker, a terminal for headphones, or the like and outputs sound information having been processed by the sound processing section 221A.

The information processing device 20B includes a communication section 21B, a control section 22B, a display section 23B, and a sound output section 24B as with the information processing device 20A including the communication section 21A, the control section 22A, the display section 23A, and the sound output section 24A. Further, the control section 22B has a function of a sound processing section 221B as with the control section 22A having the function of the sound processing section 221A.

Moreover, the communication section 21A of the information processing device 20A and the communication section 21B of the information processing device 20B are connected to each other and output sound information concerning the user Ua of the information processing device 20A and sound information concerning the user Ub of the information processing device 20B to each other. That is, the communication section 21A of the information processing device 20A outputs the sound information concerning the user Ua of the information processing device 20A from the communication section 21A and receives the sound information concerning the user Ub of the information processing device 20B from the communication section 21B of the information processing device 20B. Meanwhile, the communication section 21B of the information processing device 20B outputs the sound information concerning the user Ub of the information processing device 20B from the communication section 21B and receives the sound information concerning the user Ua of the information processing device 20A from the communication section 21A of the information processing device 20A.

Described next will be functions of the control section 22A of the information processing device 20A and the control section 22B of the information processing device 20B.

The sound processing section 221A processes the sound information acquired from the information processing device 20B via the communication section 21B and the communication section 21A, according to the information output from the communication section 12 of the server 10. Meanwhile, the sound processing section 221B processes the sound information acquired from the information processing device 20A via the communication section 21A and the communication section 21B, according to the information output from the communication section 12 of the server 10.

As described above, the information output from the communication section 12 of the server 10 to the information processing device 20A and the information processing device 20B includes the positional information concerning the first character Ca and the second character Cb in the virtual space of the game progressing on the server 10.

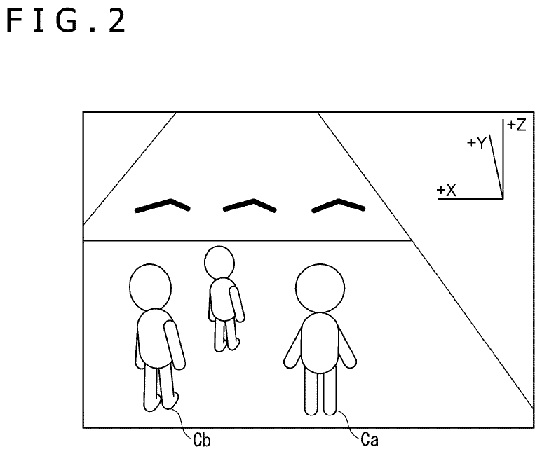

FIG. 2 through FIG. 5 are diagrams for explaining the positional information concerning the first character Ca and the second character Cb in the virtual space of the game progressing on the server 10.

In the example illustrated in FIG. 2, the first character Ca and the second character Cb are present at positions adjacent to each other in an X direction in a three-dimensional virtual space. The first character Ca corresponds to the user Ua of the information processing device 20A which is the first user, and the second character Cb corresponds to the user Ub of the information processing device 20B which is the second user. The user Ua and the user Ub use the first character Ca and the second character Cb, respectively, to participate in a common game on the server 10, and also execute voice chat in which a speech communication is performed by use of sound information without intervention of the server 10.

The communication section 12 of the server 10 outputs information including the positional information concerning the first character Ca and the second character Cb to the information processing device 20A and the information processing device 20B.

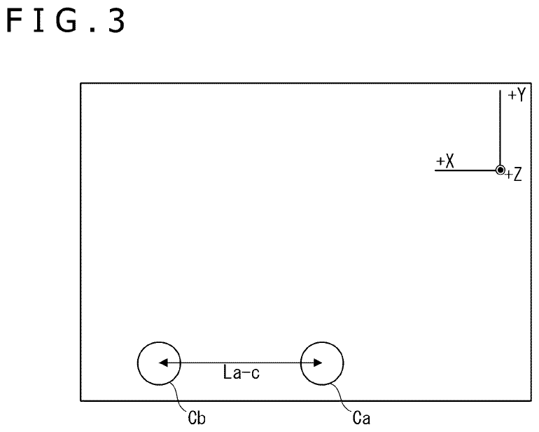

The communication section 12 of the server 10 outputs, as the positional information, a distance La-b between the first character Ca and the second character Cb in an X-Y plane and a direction Da-b in the virtual space in which direction the second character Cb is present with respect to the first character Ca in the X-Y plane, for example, as illustrated in FIG. 3.

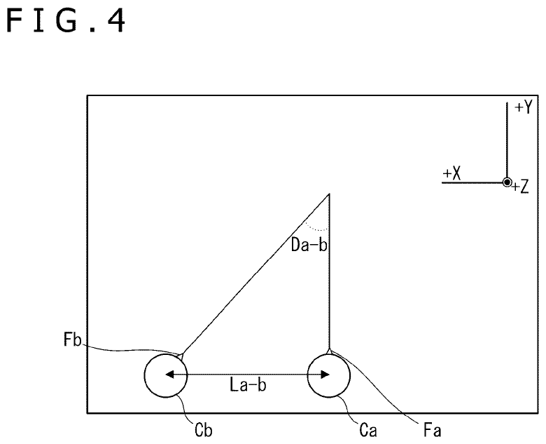

It is to be noted that the direction Da-b in the virtual space in which direction the second character Cb is present with respect to the first character Ca may be defined, for example, by an angle based on an X axis or a Y axis in the X-Y plane. Alternatively, the direction Da-b may be defined, for example, by an angle formed between a front direction Fa of the first character Ca and a front direction Fb of the second character Cb as illustrated in FIG. 4.

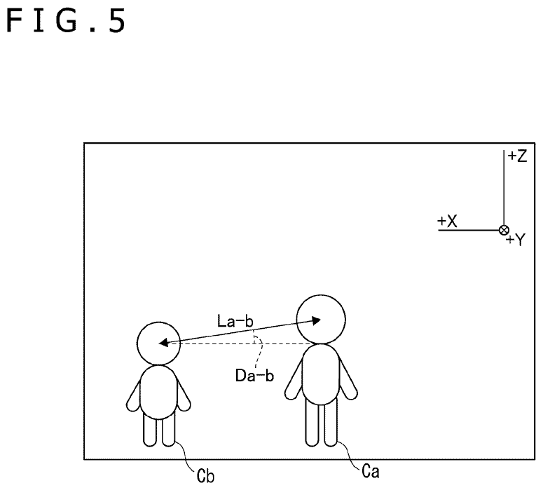

In addition, while FIG. 3 and FIG. 4 illustrate the direction Da-b in which the second character Cb is present with respect to the first character Ca in the X-Y plane and the distance La-b between the first character Ca and the second character Cb, the positional information may similarly include a direction Da-b and a distance La-b also in an X-Z plane as illustrated in FIG. 5. The same applies to a Y-Z plane not illustrated.

The sound processing section 221A processes the sound information acquired from the information processing device 20B via the communication section 21B and the communication section 21A, according to the positional information described above and the like.

The following are specific contents of processing performed on the sound information.

### (1) Processing of Sound Information According to Positional Information

The sound processing section 221A processes the sound information acquired from the information processing device 20B such that a relative positional relation between the first character Ca and the second character Cb in the virtual space of the game progressing on the server 10 agrees substantially with stereophonic sound of the sound information to be output by the information processing device 20A.

For example, in a case where the second character Cb is present at a position adjacent to the first character Ca in the +X direction in the virtual space of the game as illustrated in FIG. 2 through FIG. 5, the sound processing section 221A processes the sound information such that the sound information concerning the user Ub of the information processing device 20B is heard from the +X direction in the stereophonic sound of the sound information to be output to the user Ua of the information processing device 20A.

Such sound processing enables agreement between the relative positional relation of the users in the virtual space and the positional information in the sound information to be actually output to the user, so that the situation of the virtual space can be reflected to realize higher senses of presence and immersion.

It is to be noted that, in the example in FIG. 2 through FIG. 5, the first character Ca is present at a position adjacent to the second character Cb in the −X direction in the virtual space of the game, and hence, the sound processing section 221B of the information processing device 20B processes the sound information such that the sound information concerning the user Ua of the information processing device 20A is heard from the −X direction in the stereophonic sound of the sound information to be output to the user Ub of the information processing device 20B.

### (2) Processing of Sound Information According to Change in Positional Information

The sound processing section 221A performs processing of the sound information according to a change in the positional information, in place of or in addition to the processing of the sound information according to the positional information described in (1).

For example, in a case where the second character Cb corresponding to the user Ub of the information processing device 20B makes a significant change in its position such as falling in the virtual space, the sound processing section 221A processes the sound information acquired from the information processing device 20B, according to details of the change.

The sound processing section 221A may process the sound information acquired from the information processing device 20B, according to the details of the change, for example, in a manner with a Doppler effect. Alternatively, the sound processing section 221A may process the sound information acquired from the information processing device 20B, according to the details of the change, for example, in a manner fading in or fading out.

Such sound processing enables the change in the relative positional relation of the users to be reflected in the stereophonic sound in the sound information to be output to the user Ua of the information processing device 20A. The same applies to the sound processing performed by the sound processing section 221B of the information processing device 20B.

### (3) Processing of Sound Information According to Character Situation Information

The sound processing section 221A performs processing of the sound information according to character situation information, in place of or in addition to the processing of the sound information according to the positional information described in (1). The character situation information here is an example of incidental information concerning a character and is information indicative of a situation of each character in the virtual space. Examples of the character situation information include information indicative of an uttering situation of the character in the game progressing on the server 10, information indicative of an environment of an area where the character is present, and information indicative of a status of the character.

These pieces of information can be acquired from the information concerning the progress of the game which information is output from the communication section 12 of the server 10 to the information processing device 20A.

For example, in a case where the second character Cb corresponding to the user Ub of the information processing device 20B is using a transceiver, the sound processing section 221A performs processing of giving a feature equivalent to a transceiver sound, such as adding a noise sound, to the sound information acquired from the information processing device 20B.

Similarly, as the information indicative of the uttering situation, whether or not the second character Cb corresponding to the user Ub of the information processing device 20B is wearing a mask or a helmet, whether or not the second character Cb has been damaged, or the like may be used.

Such sound processing can have the situation of the second character Cb reflected in the sound information to be output to the user Ua of the information processing device 20A, thereby achieving a higher sense of presence.

Moreover, for example, in a case where the second character Cb corresponding to the user Ub of the information processing device 20B is present in water, the sound processing section 221A performs processing of giving a feature equivalent to sound transmission in the water, such as performing effect processing, to the sound information acquired from the information processing device 20B. Similarly, as the information indicative of the environment of the area where the character is present, whether or not the second character Cb corresponding to the user Ub of the information processing device 20B is present in an environment where voices resonate well, whether the second character Cb is present in a closed area or an open area, or the like may be used.

Such sound processing can have the environment of the area where the second character Cb is present reflected in the sound information to be output to the user Ua of the information processing device 20A, thereby achieving a higher sense of presence.

Further, for example, according to the information indicative of the status of the second character Cb corresponding to the user Ub of the information processing device 20B, the sound processing section 221A may perform processing of adding a sound effect to the sound information acquired from the information processing device 20B. For example, in a case where the status of the second character Cb corresponding to the user Ub of the information processing device 20B is a negative status such as being damaged or falling, the sound processing section 221A may add, according to the information indicative of the status, a sound effect such as a sound of being damaged or a sound of falling to the sound information acquired from the information processing device 20B. By contrast, in a case where the status of the second character Cb corresponding to the user Ub of the information processing device 20B is a positive status, the sound processing section 221A may add, according to the information indicative of the status, a sound effect such as a sound of a fanfare to the sound information acquired from the information processing device 20B.

Furthermore, for example, in a case where the status of the second character Cb corresponding to the user Ub of the information processing device 20B is a status of what is generally called respawn such as being defeated by an enemy or going out of bounds, the sound processing section 221A may perform processing of muting the sound information acquired from the information processing device 20B or turning down the sound volume thereof for a certain length of time according to the information indicative of the status.

Such sound processing can have the status of the second character Cb reflected in the sound information to be output to the user Ua of the information processing device 20A, thereby achieving higher senses of presence and immersion. The same applies to the sound processing performed by the sound processing section 221B of the information processing device 20B.

### (4) Processing of Sound Information According to Character Attribute Information

The sound processing section 221A performs processing of the sound information according to character attribute information, in place of or in addition to the processing of the sound information according to the positional information described in (1). The character attribute information here is an example of incidental information concerning a character and is information indicative of an attribute of each character. Examples of the character attribute information include information indicative of a gender of the character in the game progressing on the server 10, information indicative of an age of the character, and other pieces of information indicative of features of the character itself. These pieces of information can be acquired from the information concerning the progress of the game which information is output from the communication section 12 of the server 10 to the information processing device 20A.

For example, in a case where the gender of the second character Cb corresponding to the user Ub of the information processing device 20B is different from the gender of the user Ub, the sound processing section 221A performs processing of changing sound quality such that the sound information acquired from the information processing device 20B is converted to be suited for the gender of the second character Cb. Similarly, as the character attribute information, the age of the second character Cb corresponding to the user Ub of the information processing device 20B, a feature of the second character Cb, or the like may be used.

Such sound processing can have the attribute of the second character Cb reflected in the sound information to be output to the user Ua of the information processing device 20A. The same applies to the sound processing performed by the sound processing section 221B of the information processing device 20B.

### (5) Processing of Sound Information According to User Situation Information

The sound processing section 221A performs processing of the sound information according to user situation information, in place of or in addition to the processing of the sound information according to the positional information described in (1). The user situation information here is an example of incidental information concerning a user and is information indicative of a situation of the user Ub corresponding to the second character Cb. Examples of the user situation information include an excited state, a mental state, and the like of the user Ub. These pieces of information can be acquired from the information processing device 20B as information additional to the sound information that is output from the information processing device 20B to the information processing device 20A. The excited state and the mental state can be detected, for example, by emotion analysis based on voice volume information and the sound information.

For example, in a case where the user Ub of the information processing device 20B is in an excited state, the sound processing section 221A performs effect processing such as echoing on the sound information acquired from the information processing device 20B.

Such sound processing can have the situation of the user Ub corresponding to the second character Cb reflected in the sound information to be output to the user Ua of the information processing device 20A. The same applies to the sound processing performed by the sound processing section 221B of the information processing device 20B.

Since various known technologies can be utilized as specific techniques for the various kinds of sound processing described thus far, detailed description therefor is omitted here.

It is to be noted that the above examples illustrate the case where the items of the sound information processing described in (3) through (5) are each performed at the sound processing section 221A of the information processing device 20A.

However, it is also possible that the items of the sound information processing described in (3) through (5) are performed at the sound processing section 221B of the information processing device 20B. In this case, the communication section 21B of the information processing device 20B outputs the sound information having been processed by the sound processing section 221B to the communication section 21A of the information processing device 20A, and the sound output section 24A of the information processing device 20A outputs the sound information having been processed by the sound processing section 221B of the information processing device 20B.

Moreover, it is also possible that the items of the sound information processing described in (3) through (5) are performed at the sound processing section 221B of the information processing device 20B and the sound processing section 221A of the information processing device 20A.

In this case, the communication section 21B of the information processing device 20B outputs the sound information having been processed by the sound processing section 221B to the communication section 21A of the information processing device 20A, the sound processing section 221A of the information processing device 20A further processes the sound information having been processed by the sound processing section 221B of the information processing device 20B, and then the sound output section 24A outputs the sound information having been processed by the communication section 21B of the information processing device 20B and the sound processing section 221A of the information processing device 20A.

### Flow of Information Processing Operation

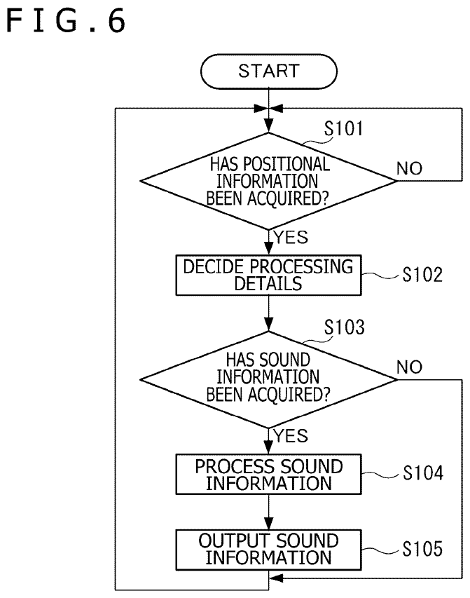

FIG. 6 is a flowchart illustrating processing operation executed by the control section 22A.

The control section 22A acquires the positional information from the server 10 via the communication section 21A (YES at step S101) and decides processing details of the sound processing (step S102).

Then, the control section 22A acquires the sound information from the information processing device 20B via the communication section 21A (YES at step S103) and causes the sound processing section 221A to process the sound information according to the processing details decided at step S102 (step S104).

The control section 22A outputs the sound information having been processed by the sound output section 24A (step S105) and returns to step S101. Also when it is not determined at step S103 that the sound information has been acquired even after elapse of a certain length of time (NO at step S103), the control section 22A returns to step S101.

That is, every time the positional information is acquired by the server 10, the processing operation of steps S101 through S105 is executed repeatedly. Hence, every time the positional information is acquired by the server 10, the sound information acquired from the information processing device 20B is processed.

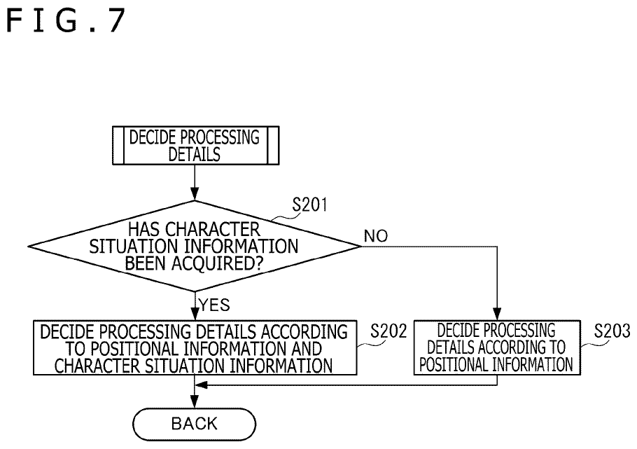

FIG. 7 through FIG. 9 are flowcharts illustrating modification examples of the processing operation executed by the control section 22A.

As described above, in a case where the sound information is processed according to the character situation information in addition to being processed according to the positional information, the control section 22A performs the following processing operation illustrated in FIG. 7 in place of step S102 in FIG. 6.

The control section 22A, when acquiring the character situation information from the server 10 via the communication section 21A (YES at step S201), decides processing details of the sound processing according to the positional information and the character situation information (step S202).

When not acquiring the character situation information (NO at step S201), on the other hand, the control section 22A decides processing details of the sound processing according to the positional information (step S203).

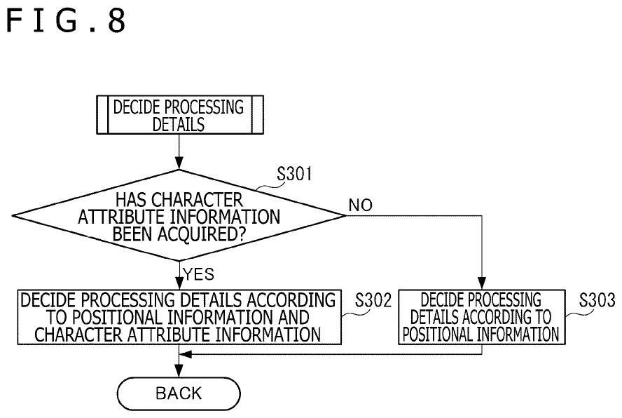

Further, as described above, in a case where the sound information is processed according to the character attribute information in addition to being processed according to the positional information, the control section 22A performs the following processing operation illustrated in FIG. 8 in place of step S102 in FIG. 6.

The control section 22A, when acquiring the character attribute information from the server 10 via the communication section 21A (YES at step S301), decides processing details of the sound processing according to the positional information and the character attribute information (step S302).

When not acquiring the character attribute information (NO at step S301), on the other hand, the control section 22A decides processing details of the sound processing according to the positional information (step S303).

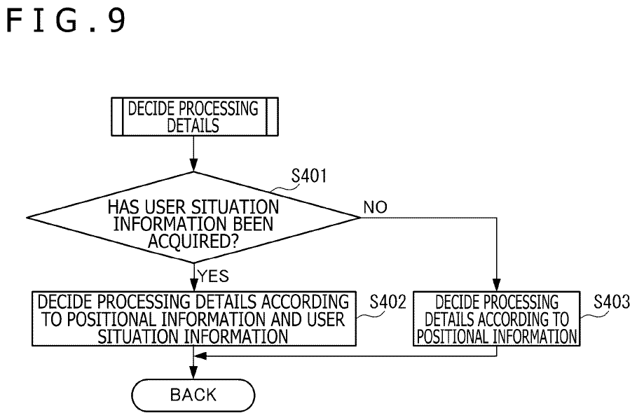

Further, as described above, in a case where the sound information is processed according to the user situation information in addition to being processed according to the positional information, the control section 22A performs the following processing operation illustrated in FIG. 9 in place of step S102 in FIG. 6.

The control section 22A, when acquiring the user situation information from the information processing device 20B via the communication section 21A (YES at step S401), decides processing details of the sound processing according to the positional information and the user situation information (step S402).

When not acquiring the user situation information (NO at step S401), on the other hand, the control section 22A decides processing details of the sound processing according to the positional information (step S403).

It is to be noted that the flows of information processing operation described with reference to FIG. 6 through FIG. 9 are similarly applied to the processing operation performed by the control section 22B of the information processing device 20B. Moreover, it is also possible that part or the whole of each processing operation described with reference to FIG. 7 through FIG. 9 is executed in combination.

### Advantageous Effect of Embodiment

The information processing device 20A according to the embodiment described above provides the following advantageous effect.

The information processing device 20A includes the communication section 21A serving as a first acquisition section that acquires positional information concerning the first character Ca corresponding to the first user Ua and the second character Cb corresponding to the second user Ub in the virtual space and as a second acquisition section that acquires sound information concerning the second user Ub, the sound processing section 221A that processes the sound information according to the relative positional relation between the first character Ca and the second character Cb in the virtual space, and the sound output section 24A that outputs the processed sound information to the first user Ua.

With such a configuration, it is possible to realize voice chat in which the situation of the virtual space is reflected in the sound information and which thus enables obtainment of higher senses of presence and immersion.

### Modifications of Embodiment

The present invention is not limited to the above embodiment, and modifications, improvements, and the like within a range within which the object of the present invention can be achieved are included in the present invention.

The processing of the sound information described in the above embodiment may normally be executed or may be executed under predetermined conditions. Further, it is also possible that whether or not to perform the processing of the sound information, the processing conditions, and the like can be set according to instructions made by a user.

In addition, while the above embodiment illustrates the case where users participate in a common game on the server 10 and perform, without intervention of the server 10, voice chat in which a speech communication is performed by use of sound information, it is also possible to perform voice chat via the server 10. That is, part or the whole of the processing operation executed at the information processing device 20A and the information processing device 20B may be executed at the server 10.

While the above embodiment illustrates the case where a plurality of users participate in a common game on the server 10 and perform, without intervention of the server 10, voice chat in which a speech communication is performed by use of sound information, the present invention can similarly be applied also to a case where a plurality of users do not participate in a common game on the server 10 but perform voice chat. In such a case, situations of the respective users can be reflected in the sound information.

### SUMMARY OF PRESENT INVENTION

The summary of the present invention will additionally be noted below.
[1]

An information processing device including:
a first acquisition section that acquires positional information concerning a first character corresponding to a first user and a second character corresponding to a second user in a virtual space;
a second acquisition section that acquires sound information concerning the second user;
a sound processing section that processes the sound information according to a relative positional relation between the first character and the second character in the virtual space; and
a sound output section that outputs the processed sound information to the first user.
[2]

The information processing device according to [1],
in which the sound processing section processes the sound information according to at least either a direction in which the second character is present with respect to the first character in the virtual space or a distance between the first character and the second character in the virtual space.
[3]

The information processing device according to [1] or [2],
in which the sound processing section processes the sound information according to a change in the positional relation.
[4]

The information processing device according to any one of [1] to [3],
in which the sound output section outputs the sound information suited for incidental information concerning the second user or the second character.
[5]

The information processing device according to [4],
in which the first acquisition section further acquires, as the incidental information, character situation information indicative of a situation of the second character in the virtual space, and
the sound processing section processes the sound information according to the positional relation and the character situation information.
[6]

The information processing device according to [5],
in which the sound processing section adds a sound effect to the sound information according to the character situation information.
[7]

The information processing device according to [4],
in which the first acquisition section further acquires, as the incidental information, character attribute information indicative of an attribute of the second character, and
the sound processing section processes the sound information according to the positional relation and the character attribute information.
[8]

The information processing device according to [4],
in which the second acquisition section further acquires, as the incidental information, user situation information indicative of a situation of the second user, and
the sound processing section processes the sound information according to the positional relation and the user situation information.
[9]

An information processing system including:
a first information processing device that is the information processing device according to any one of [1] through [8]; and
a second information processing device capable of operating a plurality of characters corresponding to a plurality of respective users in the virtual space, the second information processing device including an output section that outputs the positional information concerning the first character and the second character among the plurality of characters to the first information processing device.
[10]

An information processing method including:
a first acquisition procedure of acquiring positional information concerning a first character corresponding to a first user and a second character corresponding to a second user in a virtual space;
a second acquisition procedure of acquiring sound information concerning the second user;
a sound processing procedure of processing the sound information according to a relative positional relation between the first character and the second character in the virtual space; and
a sound output procedure of outputting the processed sound information to the first user.
[11]

An information processing program for causing a computer to execute:
a first acquisition step of acquiring positional information concerning a first character corresponding to a first user and a second character corresponding to a second user in a virtual space;
a second acquisition step of acquiring sound information concerning the second user;
a sound processing step of processing the sound information according to a relative positional relation between the first character and the second character in the virtual space; and
a sound output step of outputting the processed sound information to the first user.

### REFERENCE SIGNS LIST

1: Information processing system
10: Server
11, 22A, 22B: Control section
12, 21A, 21B: Communication section
20A, 20B: Information processing device
23A, 23B: Display section
24A, 24B: Sound output section
221A, 221B: Sound processing section

1. An information processing device comprising:
a first acquisition section that acquires positional information concerning a first character corresponding to a first user and a second character corresponding to a second user in a virtual space;
a second acquisition section that acquires sound information concerning the second user;
a sound processing section that processes the sound information according to a relative positional relation between the first character and the second character in the virtual space; and
a sound output section that outputs the processed sound information to the first user.

2. The information processing device according to claim 1,
wherein the sound processing section processes the sound information according to at least either a direction in which the second character is present with respect to the first character in the virtual space or a distance between the first character and the second character in the virtual space.

3. The information processing device according to claim 1,
wherein the sound processing section processes the sound information according to a change in the positional relation.

4. The information processing device according to claim 1,
wherein the sound output section outputs the sound information suited for incidental information concerning the second user or the second character.

5. The information processing device according to claim 4,
wherein the first acquisition section further acquires, as the incidental information, character situation information indicative of a situation of the second character in the virtual space, and
the sound processing section processes the sound information according to the positional relation and the character situation information.

6. The information processing device according to claim 5,
wherein the sound processing section adds a sound effect to the sound information according to the character situation information.

7. The information processing device according to claim 4,
wherein the first acquisition section further acquires, as the incidental information, character attribute information indicative of an attribute of the second character, and
the sound processing section processes the sound information according to the positional relation and the character attribute information.

8. The information processing device according to claim 4,
wherein the second acquisition section further acquires, as the incidental information, user situation information indicative of a situation of the second user, and
the sound processing section processes the sound information according to the positional relation and the user situation information.

9. An information processing system comprising:
a first information processing device that is the information processing device according to an information processing device including a first acquisition section that acquires positional information concerning a first character corresponding to a first user and a second character corresponding to a second user in a virtual space, a second acquisition section that acquires sound information concerning the second user, a sound processing section that processes the sound information according to a relative positional relation between the first character and the second character in the virtual space, and a sound output section that outputs the processed sound information to the first user; and
a second information processing device capable of operating a plurality of characters corresponding to a plurality of respective users in the virtual space, the second information processing device including an output section that outputs the positional information concerning the first character and the second character among the plurality of characters to the first information processing device.

10. An information processing method comprising:
acquiring positional information concerning a first character corresponding to a first user and a second character corresponding to a second user in a virtual space;
acquiring sound information concerning the second user;
processing the sound information according to a relative positional relation between the first character and the second character in the virtual space; and
outputting the processed sound information to the first user.

11. An information processing program for a computer comprising:
by a first acquisition section, acquiring positional information concerning a first character corresponding to a first user and a second character corresponding to a second user in a virtual space;
by a second acquisition section, acquiring sound information concerning the second user;
by a sound processing section, processing the sound information according to a relative positional relation between the first character and the second character in the virtual space; and
by a sound output section, outputting the processed sound information to the first user.
